(19) United States
(12) Patent Application Publication
(10) Pub. No.: US 2014/0222870 A1
(43) Pub. Date: Aug. 7, 2014

(54) System, Method, Software, and Data Structure for Key-Value Mapping and Keys Sorting

(71) Applicant: Lei Zhang, Shanghai (CN)

(72) Inventor: Lei Zhang, Shanghai (CN)

(21) Appl. No.: 13/760,221

(22) Filed: Feb. 6, 2013

(51) Int. Cl. G06F 17/30

(52) U.S. Cl. CPC G06F 17/30327
USPC 707/797

(57) ABSTRACT

A method of processing information in a database comprises providing a search expression comprising at least one character, the search expression represented by a key comprising a string of binary bit values and providing a Z-Tree comprising a plurality of key nodes each comprising a plurality of continuous bits and a key node pointer for pointing to a child node, and a plurality of branch nodes each comprising a first pointer representing zero in binary and a second pointer representing one in binary, the first pointer pointing to a left child node and the second pointer pointing to a right child node. The method includes passing the key through the Z-Tree and comparing the bit values of the key and bit values of the Z-Tree until reaching at least one of an end of the Z-Tree and an end of the key, according to an algorithm.

### BACKGROUND OF THE INVENTION

The present invention relates to a data structure for key-value mapping and keys sorting.

In software development, one may need a data structure to map keys to values or sort millions of strings.

1. For a hash table, it is difficult to define the bucket size. If the bucket size is too big, it is a waste of memory. If the bucket size is too small, there may be a lot of collisions. Resizing a hash table is also a very awkward process that requires copying keys and values from one bucket to another bucket.

2. For a hash table, if the hash code is not properly defined or the keys are not evenly distributed, there may be a lot of collisions. In the worst situation, the time complexity of adding or finding a key may be O(n).

3. Currently there is no data structure to sort a large amount of data, for example, files of several GB.

As can be seen, there is a need for solutions to these and other problems.

### SUMMARY OF THE INVENTION

In one aspect of the present invention, a method of processing information in a database comprises: i) providing a search expression comprising at least one character, the search expression represented by a key comprising a string of binary bit values; ii) providing a Z-Tree comprising: a plurality of key nodes each comprising a plurality of continuous bits and a key node pointer for pointing to a child node; and a plurality of branch nodes each comprising a first pointer representing zero in binary and a second pointer representing one in binary, the first pointer pointing to a left child node and the second pointer pointing to a right child node, iii) passing the key through the Z-Tree and comparing the bit values of the key and bit values of the Z-Tree until reaching at least one of an end of the Z-Tree and an end of the key, according to an algorithm comprising: a) if a current Z-Tree node is a branch node and a current bit value of the key is zero, the Z-Tree will go to the left child node; b) if the current Z-Tree node is a branch node and the current bit value of the key is one, the Z-Tree will go to the right child node; c) if the current Z-Tree node is a key node and bit values of the key node match current bit values of the key, the Z-Tree will go to the child node; and d) if the current Z-Tree node is a key node and the bit values of the key node do not match the current bit values of the key, the Z-Tree will return null; and iv) providing a value list of a last matching Z-Tree key node or branch node.

In another aspect of the present invention, a method of processing information in a database comprises: i) providing a search expression comprising at least one character, the search expression represented by a key comprising a string of binary bit values; ii) providing a Z-Tree comprising: a plurality of key nodes each comprising a plurality of continuous bits and a key node pointer for pointing to a child node; and a plurality of branch nodes each comprising a first pointer representing zero in binary and a second pointer representing one in binary, the first pointer pointing to a left child node and the second pointer pointing to a right child node, iii) passing the key through the Z-Tree and comparing the bit values of the key and bit values of the Z-Tree until reaching at least one of an end of the Z-Tree and an end of the key, according to an algorithm comprising: a) if a current Z-Tree node is a branch node and a current bit value of the key is zero, the Z-Tree will go to the left child node; b) if the current Z-Tree node is a branch node and the current bit value of the key is one, the Z-Tree will go to the right child node; c) if the current Z-Tree node is a key node and bit values of the key node match current bit values of the key, the Z-Tree will go to the child node; and d) if the current Z-Tree node is a key node and the bit values of the key node do not match the current bit values of the key, the key node will be split at a first different bit into a new branch node and at least one new key node; and iv) providing a value list of a last matching Z-Tree key node or branch node.

In another aspect of the present invention, a system for processing information in a database comprises: a machine; and a program product comprising machine-readable program code for causing, when executed, the machine to perform the method as described.

These and other features, aspects and advantages of the present invention will become better understood with reference to the following drawings, description and claims.

### BRIEF DESCRIPTION OF THE DRAWINGS

FIG. 1: is a flowchart showing the tree node with six bits.

FIG. 2: is a flowchart showing the branch node.

FIG. 3: is a flowchart showing the z-tree after adding keys “1”.

FIG. 4: is a flowchart showing the z-tree after adding keys “1” and “a”.

FIG. 5: is a flowchart showing the z-tree after adding keys “1”, “a” and “2”.

FIG. 6: is a flowchart showing the z-tree after adding keys “1”, “a”, “2” and “ab”.

FIG. 7: is a flowchart showing the search for key “1” and associated values from the z-tree.

FIG. 8: is a flowchart showing the automatically sorted keys in the z-tree.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Referring now to the figures, the following reference numbers may refer to elements of the invention:

10: is the z-tree search.

12: is the z-tree sort in ascending order.

This description demonstrates the design and implementation of a new data structure key-value mapping. This data structure can also be used to sort millions of strings. In software development, one may need a data structure to map values to keys or sort millions of keys. But the existing data structures have disadvantages.

The present solution is to design a new data structure, Z-Tree. In Z-Tree, all keys will be distinguished by bit values. The following table shows some example keys and their bit values. In this paper, the ASCII values instead of the UNICODE values will be used to make the demonstration simple.

| Keys | Bit Values |
|---|---|
| 1 | 00110001 |
| a | 01100001 |
| 2 | 00110010 |
| ab | 01100001 01100010 |
| long key | 01101100 01101111 01101110 01100111 00100000 |
| | 01101011 01100101 01111001 |

### Z-Tree Components

Z-Tree includes three kinds of nodes, Key Node, Branch Node and Value Node. Both Key Node and Branch Node include a pointer pointing to the Value Nodes associated with the key. The Value Nodes are optional and may vary in different applications. The Value Node will not be discussed in detail in this paper.

### Key Node

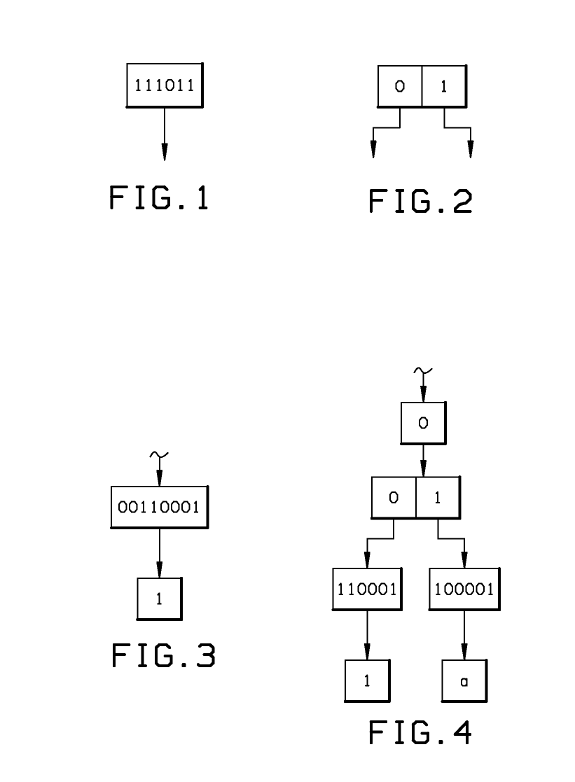

Key Node represents multiple continuous bits. Key Node includes a bit buffer together with the start bit index and the end bit index to represent multiple continuous bits. Key Node also includes a pointer pointing to the child Key Node or Branch Node and another pointer pointing to the Value Nodes. Shown in FIG. 1 is a Key Node with 6 bits “111011” (the pointer to the Value Nodes is not shown).

The following shows the Key Node definition in C/C++.

| typedef struct struKeyNode | |
|---|---|
| { | |
| //m_nFlag indicates if this is a Key Node or Branch Node | |
| unsigned int | m_nFlag; |
| //Bit buffer | |
| unsigned char * | m_pKey; |
| //Start bit index | |
| unsigned int | m_nBitStartIndex; |
| //End bit index | |
| unsigned int | m_nBitEndIndex; |
| /m_pNextNode points to the child Key Node or Branch Node | |
| void * | m_pNextNode; |
| //Value nodes | |
| void * | m_pValueList; |
| }KEY_NODE; | |

### Branch Node

Branch Node includes two pointers representing bit 0 and bit 1. The first pointer (for bit 0) points to the left child Key Node or Branch Node and the second pointer (for bit 1) points to the right child Key Node or Branch Node. Branch Node also includes a pointer pointing to the Value Nodes. FIG. 2 shows a Branch Node (the pointer to the Value Nodes is not shown).

The following shows the Branch Node definition in C/C++.

| typedef struct struBranchNodes | |
|---|---|
| { | |
| //m_nFlag indicates if this is a Key Node or Branch Node | |
| unsigned int | m_nFlag; |
| //m_pNextNodes[0] points to the left child node (bit 0) | |
| //m_pNextNodes[1] points to the right child node (bit 1) | |
| void * | m_pNextNoges[2]; |
| //Value nodes | |
| void * | m_pValueList; |
| }BRANCH_NODE; | |

### Z-Tree Operations

Z-Tree includes three kinds of operations, adding a key (and associated value) into Z-Tree, finding a key (and associated value) from Z-Tree and traversing Z-Tree to sort over the keys. Removing a key (and associated value) will not be discussed in here.

Add a Key (and Associated Value) into Z-Tree

When a new key (and associated value) is added into Z-Tree, Z-Tree will perform a loop to compare the bit values of the incoming key and the bit values of the Z-Tree nodes until reaches the end of Z-Tree or the incoming key. If the current Z-Tree node is a Branch Node and the current bit value of the incoming key is 0, Z-tree will go to the left child node. If the current Z-Tree node is a Branch Node and the current bit value of the incoming key is 1, Z-tree will go to the right child node. If the current Z-Tree node is a Key Node and the bit values of the Key

Node in Z-Tree match the current bit values of the incoming key, Z-tree will go to the child node. If the current Z-Tree node is a Key Node and the bit values of the Key Node don't match the current bit values of the incoming key, the Key Node in Z-Tree will be split at the first different bit. If the first bit is different, the Key Node in Z-Tree will be split into one Branch Node and one Key Node. If the first different bit is the last bit, the Key Node in Z-Tree will be split into one Key Node and one Branch Node. If the first different bit is in the middle of the Z-Tree Key Node, the Key Node will be split into one Key Node, one Branch Node and another Key Node. After that, Z-Tree will continue with the loop. If after reaching the end of the Z-Tree, there is still extra bits in the incoming key, Z-Tree will create a new Key Node and append it to the end of Z-Tree. The value, if there is, will be added to the value list of the last Key Node or Branch Node. The time complexity of adding a key (and associated value) is always O(1) since there is no collision between the bit values of different keys.

### Example of Adding Keys (and Associated Values) to Z-Tree

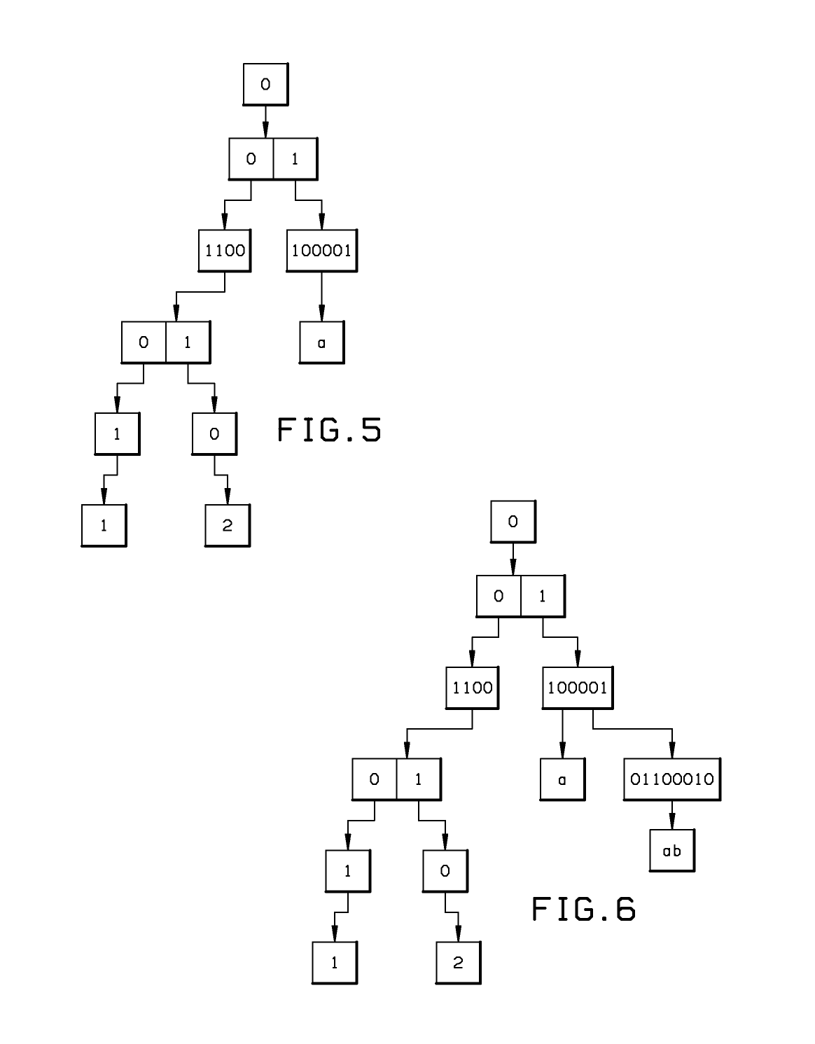

Here are some examples about adding keys (and associated values) to Z-Tree. FIG. 3 shows Z-Tree after adding a key “1” (00110001). FIG. 4 show Z-Tree after adding another key “a” (01100001). Since the second bit is different, the Key Node will be split and a Branch Node will be inserted at the second bit. Key “1” (00110001) will go to the left child tree (bit 0) and key “a” (01100001) will go to the right child tree (bit 1). FIG. 5 shows Z-Tree after adding another key “2” (00110010). This time the seventh bit is different and will be split. FIG. 6 shows Z-Tree after adding another key “ab” (0110000101100010). A new Key Node will be created at the end of Z-Tree.

Find a Key (and associated value) from Z-Tree When trying to find a key (and associated value) in Z-Tree. Z-Tree will perform a loop to compare the bit values of the incoming key and the bit values of the Z-Tree nodes until reaches the end of Z-Tree or the incoming key. If the current Z-Tree node is a Branch Node and the current bit value of the incoming key is 0, Z-tree will go to the left child node. If the current Z-Tree node is a Branch Node and the current bit value of the incoming key is 1, Z-tree will go to the right child node. If the current Z-Tree node is a Key Node and the bit values of the Key Node match the current bit values of the incoming key, Z-tree will go to the child node. If the current Z-Tree node is a Key Node and the bit values of the Key Node don't match the current bit values of the incoming key, Z-tree will return null.

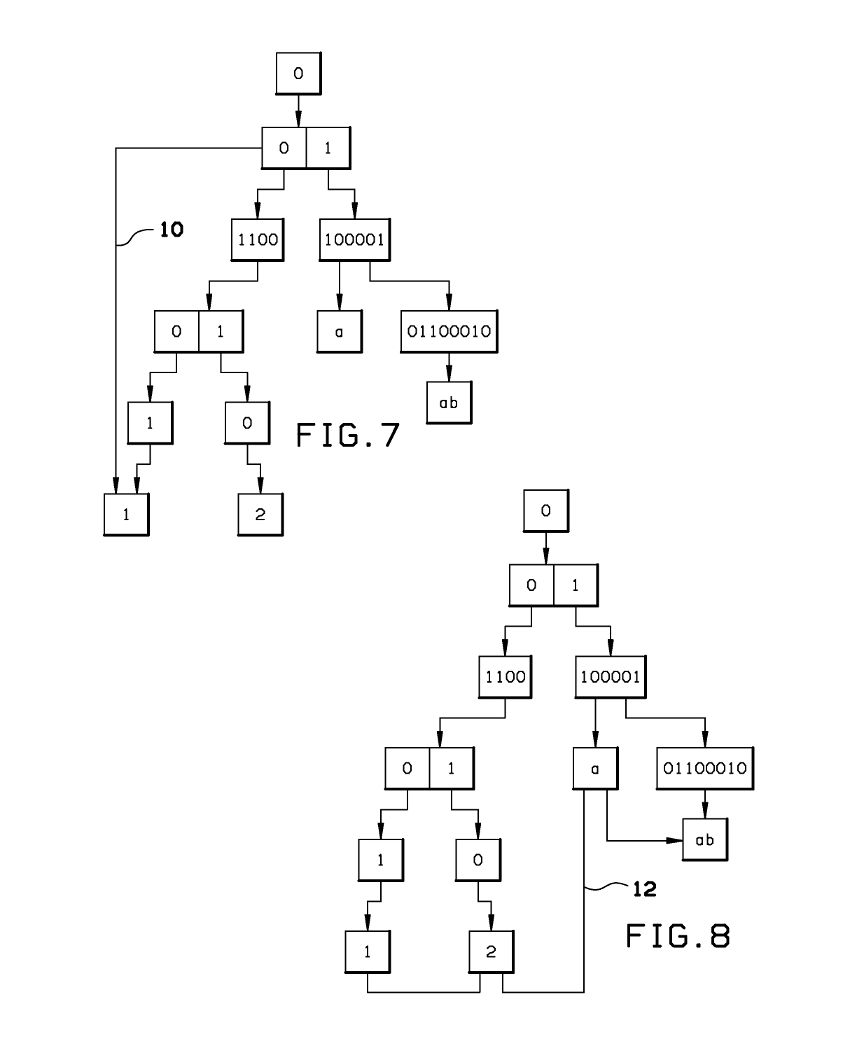

When Z-Tree reaches the end of the incoming key, the value list of the last matching Z-Tree Key Node or Branch Node will be returned. The time complexity of finding a key (and associated value) in Z-Tree is always O(1) since there is no collision between the bit values of different keys. FIG. 7 shows how to find a key “1” (and the associated value) in Z-Tree following the bit values of the key “1” (00110001).

FIG. 8 shows that the keys in Z-Tree are already sorted automatically. One can sort over the keys by traversing the Key Node and Branch Node recursively. The following steps show how to sort over the keys in ascending order. If the current node has Value Nodes, output the values. If the current node is a Branch Node, traverse the left child tree and then traverse the right child tree. If the current node is a Key Node and has a child node, go on to traverse the child tree. The time complexity of sorting with Z-Tree is O (n) which is the fastest among all sorting algorithms.

### Advantages of Z-Tree

Z-Tree has many advantages when compared with hash table and other data structures. Z-Tree will distinguish keys by bit values instead of hash code. Since the different keys must have different bit values, there is no collision between different keys. The time complexity of adding/finding a key in Z-Tree is always O (1). Z-Tree can grow automatically. There is no need to worry about the bucket size. By comparison, hash table needs to copy keys/values from one bucket to another bucket when it is growing. Since the keys in Z-Tree are sorted automatically, one can use Z-Tree to sort millions of keys. The time complexity of sorting with Z-Tree is O (n) which is the fastest among all sorting algorithms. When two keys have the same prefix, they can share the same Key Nodes and Branch Nodes for the prefix. For example, for the two keys, “Hello Tom” and “Hello Jack”, the prefix “Hello ” will be saved in the same Key Nodes or Branch Nodes. This feature can help to reduce the memory usage. While loading a file into Z-Tree, the memory size allocated for Z-Tree may be even less than the file size. That is why one can use Z-Tree to sort files of several GB. Z-Tree can be used to find all keys started with a prefix conveniently. For example, one can find all keys started with “Hello” in Z-Tree. Z-Tree can also be used to save binary keys and values.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention.

What is claimed is:

1. A method of processing information in a database, comprising:
i) providing a search expression comprising at least one character, the search expression represented by a key comprising a string of binary bit values;
ii) providing a Z-Tree comprising:
a plurality of key nodes each comprising a plurality of continuous bits and a key node pointer for pointing to a child node; and
a plurality of branch nodes each comprising a first pointer representing zero in binary and a second pointer representing one in binary, the first pointer pointing to a left child node and the second pointer pointing to a right child node,
iii) passing the key through the Z-Tree and comparing the bit values of the key and bit values of the Z-Tree until reaching at least one of an end of the Z-Tree and an end of the key, according to an algorithm comprising:
a) if a current Z-Tree node is a branch node and a current bit value of the key is zero, the Z-Tree will go to the left child node;
b) if the current Z-Tree node is a branch node and the current bit value of the key is one, the Z-Tree will go to the right child node;
c) if the current Z-Tree node is a key node and bit values of the key node match current bit values of the key, the Z-Tree will go to the child node; and
d) if the current Z-Tree node is a key node and the bit values of the key node do not match the current bit values of the key, the Z-Tree will return null; and
iv) providing a value list of a last matching Z-Tree key node or branch node.

2. A system for processing information in a database, comprising:
a machine; and
a program product comprising machine-readable program code for causing, when executed, the machine to perform the method as claimed in claim 1.

3. A method of processing information in a database, comprising:
i) providing a search expression comprising at least one character, the search expression represented by a key comprising a string of binary bit values;
ii) providing a Z-Tree comprising:
a plurality of key nodes each comprising a plurality of continuous bits and a key node pointer for pointing to a child node; and
a plurality of branch nodes each comprising a first pointer representing zero in binary and a second pointer representing one in binary, the first pointer pointing to a left child node and the second pointer pointing to a right child node,
iii) passing the key through the Z-Tree and comparing the bit values of the key and bit values of the Z-Tree until reaching at least one of an end of the Z-Tree and an end of the key, according to an algorithm comprising:
a) if a current Z-Tree node is a branch node and a current bit value of the key is zero, the Z-Tree will go to the left child node;
b) if the current Z-Tree node is a branch node and the current bit value of the key is one, the Z-Tree will go to the right child node;
c) if the current Z-Tree node is a key node and bit values of the key node match current bit values of the key, the Z-Tree will go to the child node; and
d) if the current Z-Tree node is a key node and the bit values of the key node do not match the current bit values of the key, the key node will be split at a first different bit into a new branch node and at least one new key node; and
iv) providing a value list of a last matching Z-Tree key node or branch node.

4. A system for processing information in a database, comprising:
a machine; and
a program product comprising machine-readable program code for causing, when executed, the machine to perform the method as claimed in claim 3.
